(19) United States
(12) Patent Application Publication
(10) Pub. No.: US 2009/0325062 A1
(43) Pub. Date: Dec. 31, 2009

(54) GALVANIC ELEMENT COMPRISING A NOVEL HOUSING

(76) Inventors: Rolf Brenner, Ellwangen (DE); Bernd Kreidler, Ellwangen (DE); Dejan Ilic, Ellwangen (DE); Konrad Holl, Aalen-Dewangen (DE); Jürgen Ernsperger, Neuler (DE)

Correspondence Address: IP GROUP OF DLA PIPER LLP (US), ONE LIBERTY PLACE, 1650 MARKET ST, SUITE 4900, PHILADELPHIA, PA, 19103, US

(21) Appl. No.: 12/095,328

(22) PCT Filed: Nov. 30, 2006
(86) PCT No.: PCT/EP2006/011491

§ 371 Date: Mar. 2, 2009

(30) Foreign Application Priority Data
Nov. 30, 2005 (DE) 102005058132.3

(51) Int. Cl. H01M 2/08; H01M 4/82

(52) U.S. Cl. 429/174; 29/623.2

(57) ABSTRACT

A galvanic element having a housing including a housing cup, a housing cover, and a film seal that isolates the housing cup from the housing cover, wherein the housing cover includes a cover base, an adjacent cylindrical section and an adjacent edge section, and wherein the edge of the housing cover is bent around inwardly or outwardly in the edge section.

### RELATED APPLICATIONS

This is a §371 of International Application No. PCT/EP2006/011491, with an international filing date of Nov. 30, 2006 (WO 2007/062838 A1, published Jun. 7, 2007), which is based on German Patent Application No. 102005058132.3, filed Nov. 30, 2005.

### TECHNICAL FIELD

This disclosure relates to galvanic elements, in particular, button cells having a housing comprising a housing cup, a housing cover and a film seal, which isolates the housing cup from the housing cover, and to methods for producing galvanic elements.

### BACKGROUND

Galvanic elements, in particular, those in the form of button cells, normally have a housing comprising a housing cup (often also referred to as a housing pan) and a housing cover. By way of example, the housing cup may be produced from nickel-plated deep-drawn metal sheet as a stamped and drawn part. The housing cup is normally of positive polarity, and the housing cover of negative polarity. Galvanic elements such as these may contain widely different electrochemical systems, for example zinc/manganese dioxide, primary lithium systems or else secondary systems such as nickel/cadmium, nickel/metal hydride or secondary lithium systems.

Cells such as these are normally closed in a liquid-tight manner by peening over the cup edge over the edge of the housing cover in conjunction with a plastic ring which is arranged between the housing cup and the housing cover and at the same time acts as a sealing element as well as providing isolation between the housing cup and the housing cover. By way of example, button cells such as these are disclosed in DE 31 13 309.

The sealing elements for these button cells are normally produced by injection molding methods, for example, from polyamides. The injection molds for this purpose are expensive and complex to maintain. Furthermore, it is virtually impossible to produce sealing elements with wall thicknesses of less than 0.3 mm by injection molding. Seals produced by injection molding methods in consequence occupy a relatively large volume and therefore adversely affect the utilization of the capacity of a cell, which can play a major roll, especially in the case of button cells.

DE 196 47 593 discloses a sealing element which is produced by thermoforming from a film. A cup-shaped molding is drawn from a heated film by means of a drawing matrix and a molding stamp, in a vacuum. Polyamides are specified as the preferred film material. The forming process is carried out as a function of the desired diameter/height ratio in one or more graduated processes. A cutting stamp and a cutting bush are then used for stamping out in the base area of the cup-shaped molding, produced by thermoforming. The sealing element produced in this way is mounted on a housing cover, which can then be inserted in a housing cup. Depending on the chosen process parameters, the method described in DE 196 47 593 can be used to produce sealing elements up to 5 mm high with very uniform wall thicknesses. In this case, the thickness from the initial material is preferably in the range between 0.1 mm and 0.3 mm. For example, if a film with a thickness of 0.15 mm is used as the initial material, a wall thickness of about 0.12 mm can be achieved.

The use of a film seal which is as thin as this increases the available internal volume of a galvanic cell of the type mentioned above, and therefore results in a significant capacity improvement.

When using conventional single-walled housing covers, (prior art schematically illustrated in FIG. 1) in conjunction with sealing elements comprising films, problems have, however, occurred. Conventional covers are very unstable, particularly in the edge area. They frequently have sharp cut edges at the edge which, in unfavorable circumstances, can cut through a film that is used as a sealing element. In addition, the contact area of covers such as these is very small, so that even a slight pressure may result in part of the cover together with the film seal entering the cathode.

Housing covers with a double-walled housing casing formed by swaging of the edge are also known such as in DE 196 47 593. Their use is intended to solve the problems that have been mentioned and which occur in conjunction with film seals. The use of such housing covers improves robustness, no sharp edges occur in the edge area, and the contact area of such covers is also considerably greater than that of conventional housing covers.

However, the use of double-walled housing covers has a negative influence on the available internal volume in a cell. The capacity increase which can theoretically be achieved by the use of film seals is in consequence not achieved.

It could therefore be advantageous to provide a galvanic cell of the type mentioned initially, which is distinguished by an improved internal volume and therefore improved capacity utilization, while at the same time avoiding the occurrence of the problems mentioned above.

### SUMMARY

We provide a galvanic element having a housing including a housing cup, a housing cover, and a film seal that isolates the housing cup from the housing cover, wherein the housing cover includes a cover base, an adjacent cylindrical section and an adjacent edge section, and wherein the edge of the housing cover is bent around inwardly or outwardly in the edge section.

We also provide a method for producing the galvanic element, including assembling the housing including a housing cover with an edge which is bent around inwardly or outwardly, a housing cup and a film seal, with the edge of the housing cup being peened over, and with the housing cup being drawn radially inwardly in an area of the cup base during or after peening.

### BRIEF DESCRIPTION OF THE DRAWINGS

FIG. 1 is a cross section taken through a conventional housing cover with a film seal according to the prior art (partial view);

FIG. 2 is a partial view of the housing of a galvanic element (cross section) with a housing cover bent around outwardly in an L-shape;

FIG. 2a is a cross section taken through the edge area of a housing cover which has been bent around outwardly;

FIG. 2b is a cross section taken through the edge area of a housing cover which has been bent around in an L-shape;

FIG. 3 is a partial view of the housing of a galvanic element (cross section) with a housing cover bent around inwardly;

FIG. 4 is a further partial view of the housing of a preferred galvanic element (cross section) with a housing cover bent around inwardly;

FIG. 5 is a partial view of the housing of a galvanic element (cross section) with a housing cover turned outwardly in a U-shape;

FIG. 6 is a cross section taken through the housing cover of the housing illustrated in FIG. 5;

FIG. 7 is a partial view of the housing of a galvanic element (cross section) with a housing cover bent around outwardly in a U-shape;

FIG. 8 is a partial view of the housing of a galvanic element (cross section) with a housing cover bent around outwardly in a U-shape; and

FIG. 9 shows a schematic illustration of the manufacture of a completely assembled component comprising a housing cover and film seal with an additionally introduced sealing compound in the edge section of the housing cover; the components are illustrated in the form of details, in cross section.

### DETAILED DESCRIPTION

It will be appreciated that the following description is intended to refer to specific examples of structure selected for illustration in the drawings and is not intended to define or limit the disclosure, other than in the appended claims.

A galvanic element is, in one particularly preferred structure, in the form of a button cell. This has a housing with a housing cup, a housing cover and a film seal. The latter isolates the housing cup from the housing cover.

In particular, a galvanic element is distinguished by its housing cover which has a cover base, a cylindrical section adjacent to it, and an edge section adjacent to it, with the edge of the housing cover being bent around inwardly or outwardly in the edge section.

The process of bending the housing cover around means that any sharp cut edges which may occur at the edge of the housing cover are not at right angles to the film seal, thus greatly reducing the risk of damage to the film seal.

Furthermore, a galvanic element also makes considerably better use of the capacity, in addition to the improved safety characteristics, which have already been mentioned, relating to damage to the film seal. In contrast to the galvanic elements known from DE 196 47 593, with a double-walled housing casing formed by swaging the edge, the edge in our case is only bent around in the edge section. In our case, there is no broad, double-walled area, as the housing covers which are known from the prior art have. This means that the internal volume of the housing of a galvanic element is restricted only in the edge section.

In one particularly preferred structure, the edge section of a galvanic element has an essentially L-shaped cross section. The bent-around edge may in this case preferably be arranged essentially at right angles to areas of the edge section which are not bent around, that is to say bent outwardly or inwardly, starting from this, through about 80° to about 100°, preferably about 85° to about 95°, in particular about 90°. The angle between the bent-around edge of the housing cover and the cylindrical section is then preferably more than about 90°, in particular about 95° to about 115°, particularly preferably about 105° to about 110°.

However, discrepancies from this right-angle arrangement are also possible. For example, the bent-around edge of the housing cover may also be erected at an angle of about 90° with respect to the cylindrical section. The angle between the bent-around edge and that part of the edge section which is not bent around is then less than about 90°, preferably about 65° to about 75°, and in particular about 70°.

In a further preferred structure, the edge section of a galvanic element has an essentially U-shaped cross section. The edge is bent around outwardly or inwardly so far that the bent-around area is aligned essentially parallel to areas of the edge section which have not been bent around. Starting from this it is therefore bent around outwardly or inwardly through about 180°, so that it is also possible to refer to this as a swaged edge.

There may be a gap between the areas that are aligned parallel to one another. However, the bent-around edge area preferably rests directly on the housing cover, on the outside or inside.

In structures in which the edge is bent around outwardly, it is also preferable for the bent-around edge to be drawn radially inwardly. This applies both to galvanic elements where the edge is bent around outwardly in an L-shape and those in which the edge is bent around outwardly in a U-shape.

In these structures, in the edge section, the housing cover preferably has a maximum external diameter which corresponds essentially to the external diameter of the cylindrical section which is arranged above the edge section. The internal diameter of the edge section in this structure is narrower than the internal diameter of the cylindrical section.

Particularly in the case of galvanic elements with an edge which is bent around outwardly in a U-shape, it may also be preferable for the external diameter of the edge section to be slightly greater than that of the cylindrical section, as this may be advantageous for sealing of galvanic elements (the edge section in a completely assembled housing presses firmly on the cup edge or on a film seal which is arranged between the cup edge and the housing cover). In these structures, the outward discrepancy is preferably less than about 50% of the wall thickness of the housing cover.

In a further preferred structure, a galvanic element has a housing which comprises a housing cup with a cup base and an essentially cylindrical cup casing, as well as a housing cover with a cover base and a circumferential, essentially cylindrical section. A film seal isolates the housing cup and the housing cover from one another. The cylindrical section of the housing cover rests on the inner wall of the housing cup when the housing is in the closed state. An edge section is adjacent to it. It is preferable for this to be seated in the base area of the housing cup, when the housing is in the closed state. The cylindrical section of the housing cover preferably has an essentially uniform external diameter over its entire length, which is matched to the corresponding internal diameter of the housing cup. In contrast to this, the external diameter of the housing cover in this preferred structure is not constant in the edge section, since the edge of the housing cover is bent around outwardly in a U-shape, and is drawn radially inwardly. The external diameter of the housing cover in the edge section preferably does not exceed the external diameter of the cylindrical cover section anywhere. As already mentioned above, preferred structures also exist, however, in which the external diameter of the edge section may be slightly greater than that of the cylindrical section.

It is preferable for less than about 0.5 mm of the housing cover of a galvanic element to be bent around outwardly or inwardly, particularly swaged. About 0.1 mm to about 0.35 mm, in particular only about 0.25 mm, is particularly preferable. These numbers also indicate the difference from the prior art, from which only housing covers with a double-walled area formed by swaging the edge are known, which area generally extends at least over half the height (several millimeters) of the housing cover.

The film seal of a galvanic element is, in particular, formed from a film which can be thermoformed. In principle, conventional plastics which can be thermo-formed may be used for this purpose, in particular, including composites and sandwich structures comprising a plurality of different plastics. It is particularly preferable for the film seal to be formed from a polyamide.

In a further preferred structure, the film seal is formed from a film which is resistant to high temperatures. Film seals composed of a film which is resistant to high temperatures are particularly suitable for button cells which are used in the field of electronics. In this case, boards are fitted with button cells and further (in particular electrical) components, and are soldered in a wave bath or using the reflow technique. During this process, the button cells may be briefly heated to temperatures of up to about 250° C. Seals composed of polyethylene or from polyamides have already softened, or lost their shape at these temperatures. This results in leaks and cells running out.

In one particularly preferred structure, the film seal is therefore formed from polyaryletheretherketone (PEEK). Seals composed of this material can be heated to about 250° C. over long periods, and briefly even to about 300° C. Because of its flowing characteristics, seals composed of PEEK cannot be produced by injection molding. However, as a film, it can be drawn slightly to form a seal.

The film seal of an element is preferably produced as a molding, as described in DE 196 47 593. It is preferable for the molded seal produced in this way to be mounted, after its production, on a housing cover which can then be inserted into a housing cup. When the housing of a galvanic element is in the closed state, the film seal is preferably arranged circumferentially on the housing cover, in which case it is also preferable for it to have an overlap, pointing into the cell interior, in the edge area of the housing cover. The film seal preferably extends sufficiently in the direction of the cover base to preclude direct contact between the housing cup and the housing cover when the housing cup is peened over.

In one preferred structure, the film seal is shrunk onto the housing cover. DE 196 47 593, the subject matter of which is incorporated by reference, also describes the shrinking process.

Film seals are preferably used which have a thickness of between about 0.01 mm and about 0.3 mm. It is particularly preferable to use film seals with a thickness of between about 0.01 mm and about 0.15 mm, and in particular of between about 0.08 mm and about 0.12 mm.

In one preferred structure of a galvanic element, a sealing compound is introduced between the film seal and the cover in the edge section of the housing cover, in particular, to provide sealing against creepage effects. The sealing compound is preferably bitumen or a polyamide adhesive.

The housing cup and the housing cover of a galvanic element are preferably made of metal. By way of example, nickel-plated deep-drawn metal sheet is suitable for use as a metallic material. Inter alia, trimetals are also preferred, for example, with the sequence nickel, steel (or stainless steel) and copper (from the outside inwardly).

The housing cover of a galvanic element is surprisingly highly robust, because of its configuration in the edge section. While conventional housing covers without a swaged-over edge in the edge area are highly unstable and, therefore, for robustness reasons, can frequently be used only as a housing cover with relatively thick wall thicknesses, the housing covers of a galvanic element can also be used with very thin walls.

It is particularly preferable for the housing cover of a galvanic element to have a wall thickness of between about 0.08 mm and about 0.2 mm, in particular of between about 0.1 mm and about 0.15 mm.

The housing cover preferably has a height of between about 2 mm and about 15 mm, particularly preferably of between about 2 mm and about 10 mm, and in particular of between about 3 mm and about 6 mm.

The housing cover of a galvanic element is particularly robust in response to radial pressure in the edge section. This robustness advantageously provides the capability to further improve the sealing characteristics of the housing of a galvanic element.

A galvanic element is particularly preferable when it has a housing cup which is drawn radially inwards in the area of the cup base.

The process of drawing in the cup base allows radial pressure to be produced on that edge section of the housing cover which rests on the inner wall of the housing cup. The film seal which is arranged between the housing cup and the housing cover is therefore compressed in this area, thus resulting in a galvanic element having a considerably better leakage behavior. The drawing-in process can, in particular, be carried out during or after the peening of the housing cup which follows the fitting of the galvanic element.

A galvanic element preferably has an external diameter which is reduced by about 0.01 mm to about 0.15 mm, preferably by about 0.05 mm to about 0.1 mm, in the area of the indent.

Methods for producing galvanic elements are also the subject matter of this disclosure. A method comprises assembly of the housing comprising a housing cover with an edge which is bent around inwardly or outwardly, a housing cup and a film seal. The edge is preferably drawn inwardly, as has been described above. The method is distinguished inter alia in that the housing cup is drawn radially inwardly in the area of the cup base during or after the peening process. The drawing-in process is in this case preferably carried out by means of a calibration bush. Before the housing is fitted, the housing parts can be filled with the components (electrode materials, separator and electrolyte) involved in the electrochemical process.

The process of drawing in the housing cup has already been mentioned. The housing components (housing cup, housing cover and film seal) to be used in the method have also already been explained in detail above. Express reference is therefore made to the corresponding sections of the description in this case.

Selected aspects of our elements and methods will become evident from the description of the examples which now follow and from the drawings. In this case, individual features may be implemented on their own or in combination with one another. The described structures are intended only for explanation and to assist understanding, and should not be regarded as having any restrictive effect.

Turning now to the Drawings, FIG. 1 shows a conventional housing cover 101 which may have a sharp cut edge in the edge area 102 which, in poor circumstances, could cut through a film used as a sealing element 103.

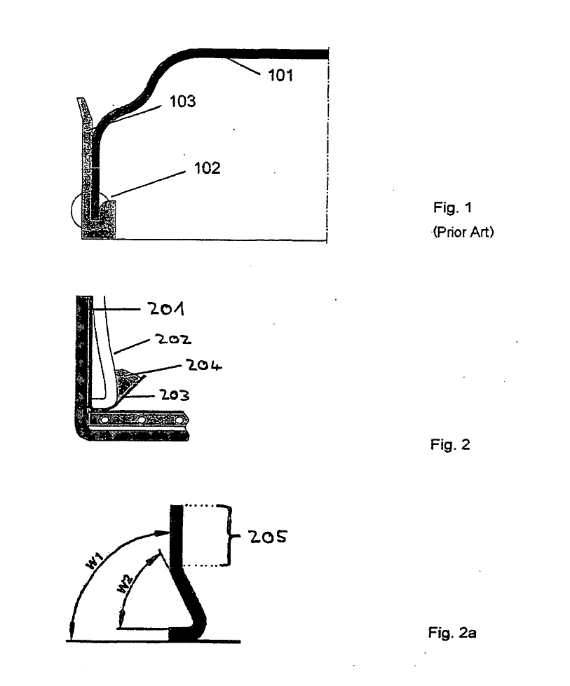

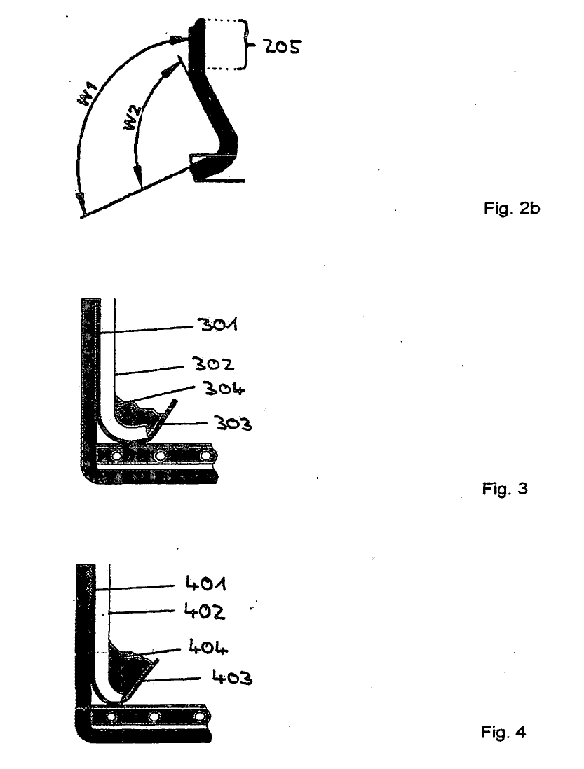

FIG. 2 shows a partial view of the housing of one preferred structure of a galvanic element (cross section) with a housing cover bent around outwardly in an L-shape. The illustration shows the housing cup 201, the edge section of the housing cover 202, a film seal 203 and a sealing compound 204 which has been introduced between the film seal 203 and the housing cover 202. The bent-around edge of the housing cover 202 is aligned at an angle of about 90° to the cylindrical section (not illustrated). The angle between the bent-around edge and the part of the edge section which has not been bent around is less than 90°. The bent-around edge has been drawn inwardly, so that the maximum external diameter of the housing cover in the edge area 202 corresponds essentially to the external diameter of the cylindrical section, which is not illustrated.

FIG. 2a shows a cross section through the edge area of a housing cover which has been bent around outwardly, with the bent-around edge having been drawn inwardly. The bent-around edge of the housing cover is aligned at an angle W1 of about 90° to the cylindrical section 205 (only partially illustrated). The angle W2 between the bent-around edge and the part of the edge section which has not been bent around is considerably less than 90°.

FIG. 2b shows an L-shaped edge section of a housing cover 202, with the bent-around edge having been drawn inwardly. In this case, the bent-around edge of the housing cover is aligned at an angle W1 of considerably more than 90° to the cylindrical section 205 (only partially illustrated). The angle W2 between the bent-around edge and the part of the edge section which is not bent around is about 90°.

FIG. 3 shows a partial view of the housing of one preferred structure of a galvanic element (cross section) with a housing cover (partially illustrated) with an edge which has been bent around inwardly. The illustration shows the housing cup 301, the housing cover 302, a film seal 303 and a sealing compound 304 which has been introduced between the film seal 303 and the housing cover 302.

FIG. 4 shows a partial view of a further housing of one preferred structure of a galvanic element (cross section) with a housing cover (partially illustrated) with an edge bent around inwardly. The illustration shows the housing cup 401, the housing cover 402, a film seal 403 and a sealing compound 404 which has been introduced between the film seal 403 and the housing cover 402.

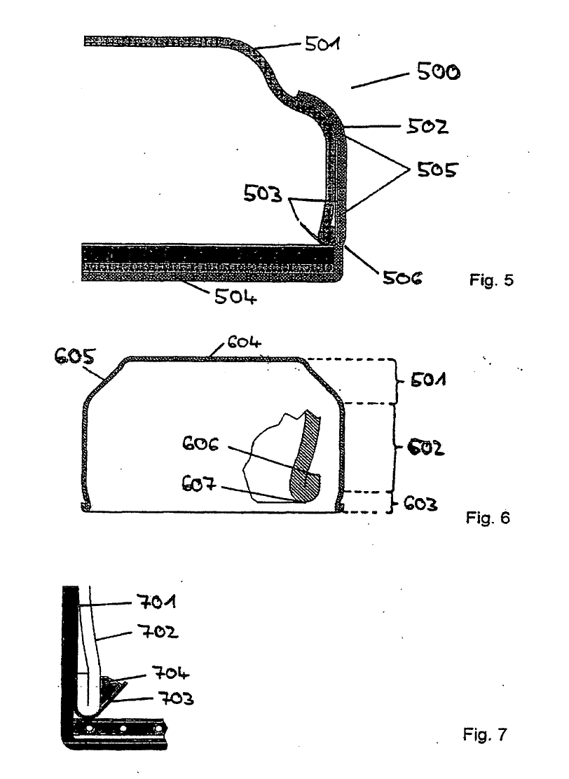

FIG. 5 shows a partial view, in the form of a cross section, of the housing 500 of one preferred structure of a galvanic element. The housing has a housing cover 501 and a housing cup 502. A film seal 503 is arranged between the housing cover and the housing cup, is passed in the lower area of the housing around the rounded edge of the housing cover, and slightly overlaps into the cell interior. The housing cup has a cup base 504 and an essentially cylindrical cup casing 505, which is peened over in the upper area. In the base area, the housing cup has a slight indent 506.

FIG. 6 shows a cross section through the housing cover 501 from FIG. 5. The cover can be roughly subdivided into three areas, specifically the cover base 601, the essentially cylindrical section 602, and the edge section 603 adjacent to it. The cover base has a planar central section 604 and a bent edge 605. The edge section is additionally illustrated enlarged, as an aspect of great interest. This clearly shows the swaged cut edge 606 and the rounded cover edge 607.

FIG. 7 shows a partial view of the housing of one preferred structure of a galvanic element (cross section) with a housing cover bent around outwardly in a U-shape. The illustration shows the housing cup 701, the edge section of the housing cover 702, a film seal 703 and a sealing compound 704 which has been introduced between the film seal 703 and the housing cover 702. The bent-around edge has been drawn inwardly and is aligned parallel to the cup inner wall.

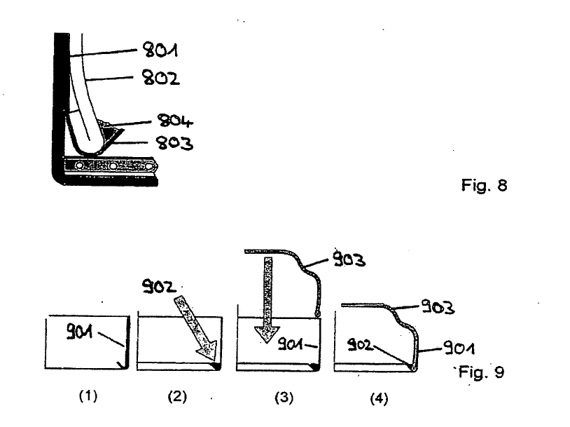

FIG. 8 shows a further partial view of the housing of one preferred structure of a galvanic element (cross section) with a housing cover which has been bent around outwardly in a U-shape. The illustration shows the housing cup 801, the edge section of the housing cover 802, a film seal 803 and a sealing compound 804 which has been introduced between the film seal 803 and the housing cover 802. The bent-around edge has been drawn inwardly, but is not aligned parallel to the cup inner wall.

FIG. 9 schematically illustrates the manufacture of a housing cover provided with a film seal. At (1), a film seal 901 is provided as a thermoformed molding with a recess, pointing inwardly, at the lower end. At (2), the recess is filled with sealing compound 902. At (3), the film seal 901 is fitted to a housing cover 903. (4) shows a completely assembled component comprising a housing cover 903 and a film seal 901, with an edge section that has been sealed by sealing compound 902.

### Example 1

A button cell of conventional design has a housing with a housing cup with a wall thickness of 0.1-0.2 mm, a film seal with a thickness of 0.03-0.05 mm, and a housing cover with a thickness of 0.1-0.2 mm. This results in an overall structure thickness of 0.23-0.45 mm. However, the housing cover has been found to be too unstable at the edge. The thickness of the cover is doubled in the edge area by folding the housing cover around in the edge area over a length of 0.25 mm. The external size of the housing cover is then calibrated in the edge area. The cover that has been reinforced in this way satisfies the mechanical requirements considerably better. This reliably avoids the film seal being cut into and damage to the cathode during the subsequent assembly of a button cell.

### Example 2

A cell as described in Example 1 has its diameter drawn in by 0.05-0.1 mm over a length of 0.4 mm in the base area after the peening process. This has resulted in the inside of the housing cup being pressed via the film seal against the robust edge of the cover. The items produced in this way offer considerably better leakage behavior.

1-17. (canceled)

18. A galvanic element having a housing comprising:
a housing cup;
a housing cover; and
a film seal that isolates the housing cup from the housing cover,
wherein the housing cover comprises a cover base, an adjacent cylindrical section and an adjacent edge section, and wherein the edge of the housing cover is bent around inwardly or outwardly in the edge section.

19. The galvanic element as claimed in claim 18, wherein the edge section with the edge which is bent around outwardly or inwardly has an essentially L-shaped cross section.

20. The galvanic element as claimed in claim 18, wherein the edge section with the edge which is bent around outwardly or inwardly has an essentially U-shaped cross section.

21. The galvanic element as claimed in claim 18, wherein the edge is bent around outwardly and is drawn radially inwardly.

22. The galvanic element as claimed in claim 21, wherein, in the edge section, the housing cover has a maximum external diameter which corresponds essentially to an external diameter of the cylindrical section.

23. The galvanic element as claimed in claim 18, comprising a housing cup with a cup base and an essentially cylindrical cup casing,
a housing cover with a cover base, a circumferential, essentially cylindrical section which rests on an inner wall of the housing cup when the housing is in a closed state, and an adjacent edge section, and
a film seal which isolates the housing cup and the housing cover from one another,
wherein the edge of the housing cover is swaged around outwardly in a U-shape, and is drawn radially inwardly, in the edge section.

24. The galvanic element as claimed in claim 18, wherein the film seal is formed from a film which can be thermoformed.

25. The galvanic element as claimed in claim 18, wherein the film seal is formed from a polyamide.

26. The galvanic element as claimed in claim 18, wherein the film seal is formed from a film which is resistant to high temperatures.

27. The galvanic element as claimed in claim 26, wherein the film seal is formed from polyaryletheretherketone.

28. The galvanic element as claimed in claim 18, wherein the film seal has a thickness of between about 0.01 mm and about 0.3 mm.

29. The galvanic element as claimed in claim 18, wherein a sealing compound is located between the film seal and the housing cover in the edge section of the housing cover.

30. The galvanic element as claimed in claim 18, wherein the housing cup and/or the housing cover are/is metal.

31. The galvanic element as claimed in claim 18, wherein the housing cover has a wall thickness of between about 0.08 mm and about 0.2 mm.

32. The galvanic element as claimed in claim 18, wherein the housing cup is drawn radially inwards in the area of the cup base.

33. The galvanic element as claimed in claim 32, wherein the housing cup has an external diameter which is reduced by about 0.01 mm to about 0.15 mm, in the area of an indent.

34. A method for producing a galvanic element as claimed in claim 18, comprising assembling the housing comprising a housing cover with an edge which is bent around inwardly or outwardly, a housing cup and a film seal, with the edge of the housing cup being peened over, and with the housing cup being drawn radially inwardly in an area of the cup base during or after peening.
